(19) United States
(12) Patent Application Publication
(10) Pub. No.: US 2024/0097424 A1
(43) Pub. Date: Mar. 21, 2024

(54) Self-Retractable Wire Reel

(71) Applicant: Spirit Specialty Solutions Inc., Broomall, PA (US)

(72) Inventors: Michael Kurmlavage, Monroeville, NJ (US); Muhammad Jibran Arshad, Peshawar (PK)

(73) Assignee: Spirit Specialty Solutions Inc., Broomall, PA (US)

(21) Appl. No.: 18/454,301

(22) Filed: Aug. 23, 2023

Related U.S. Application Data
(60) Provisional application No. 63/406,852, filed on Sep. 15, 2022.
(60) Provisional application No. 63/406,857, filed on Sep. 15, 2022.
(60) Provisional application No. 63/406,863, filed on Sep. 15, 2022.
(60) Provisional application No. 63/406,868, filed on Sep. 15, 2022.

(51) Int. Cl. H02G 11/02

(52) U.S. Cl. CPC H02G 11/02

(57) ABSTRACT

A self-retractable wire reel for supplying electrical contacts to electronic devices. The self-retractable wire reel includes a housing having a drum positioned between a pair of brackets that rotates relative to the brackets. A wire threaded through a slot in one of the brackets to access an inner spool area and passes through a drum aperture to be wound about a sidewall of an outer spool area. A spring is engaged with the drum such that the drum is biased in a first direction. In a first direction, the drum causes an outfeed section of the wire to retract towards the housing. As the outfeed section of the wire is pulled away from the housing in an extended configuration, the infeed section of the wire leading from the external power source experiences a tensioning force on the wire.

### CROSS REFERENCE TO RELATED APPLICATION

This application claims the benefit of U.S. provisional application No. 63/406,852 filed on Sep. 15, 2022, U.S. provisional application No. 63/406,857 filed on Sep. 15, 2022, U.S. provisional application No. 63/406,863 filed on Sep. 15, 2022, and U.S. provisional application No. 63/406,868 filed on Sep. 15, 2022; the above identified patent applications are herein incorporated by reference in their entirety.

### BACKGROUND OF THE INVENTION

The present invention relates to a self-retractable wire reel. The present invention further provides a self-retractable wire reel having a housing with rotatable drum that is adapted to receive a wire therethrough, such that an electrical connector positioned at an end of an outfeed section of the wire is adapted to electronically couple with an electronic device.

Electronic devices, such as tablets, phones, and displays, require a wired connection to an external power source to supply power and charge the device or to otherwise communicate with other systems and devices. In many settings, these wired electronic devices can easily become disconnected, either through unintentional separation or by catching on other objects. Additionally,

Proper wire management is critical to ensure continued functioning of the devices as well as to reduce potential hazards. Wire management involves the organization, securing, and routing of electrical wires, cables, and cords in a neat and efficient manner. Neatly managed wires allow for easier access during maintenance, repairs, or upgrades. When cables are organized and properly labeled, troubleshooting becomes more efficient. Identifying and replacing faulty components becomes quicker, reducing downtime and enhancing productivity. Wire management contributes to the aesthetics of a space. Well-organized wires create a visually appealing environment, whether it is a home, office, or any other setting. Concealed or neatly arranged wires contribute to a professional and clutter-free appearance, improving the overall ambiance. Furthermore, wire management protects cables from damage. Abrasion, bending, or excessive strain can lead to wire wear and tear.

To improve wire management, there are several effective strategies to consider. One important aspect is cable organization. By using cable ties, Velcro straps, or cable clips, wires can be bundled and secured together, preventing tangling and keeping them organized for easy identification and tracking.

However, in many situations the electronic device needs to be repeatedly moved and repositioned. When multiple wires are secured together, additional work is required to adjust a single wire. The bundle must be unbound to identify the wire that potentially needs more slack or less slack, and then the wires must be rebounded to form the bundle again.

Another solution is to utilize a reel or spool that is retractable. These reels have several limitations. First, these reels often utilize a latch that must be engaged and disengaged to allow for the wire to be pulled from the reel. The latch is hard to access or positioned away from the electronic device. The latch may need to be actuated again to pull or retract the wire into the reel. Second, when pulling the wire out from the reel, the infeed section of the wire is consequently pulled as well. This can lead to decoupling of the infeed section from the external power source.

In one example, many cooking grills and other cooking apparatuses at convenience stores cook food and display a sign with the types of food items contained on the grill. The grill operator at the convenience store or other retail store will place the items to be cooked, such as hot dogs, flavored sausage, and the like, to the rear of a grill. Customers often rely on clear labeling and information about the food they consume because it can be difficult for a customer to identify the food item or the flavor of food item by looking at the food item alone. These signs may be electronic and often have to be moved repeatedly as the food is taken or transferred to other parts of the grill. As the food is repositioned or replaced, the sign is also moved accordingly.

Since these signs need to be moved repeatedly over a hot surface, the wire management of each sign is vitally important, as they may become damaged from the heat. Moreover, the wire from the external source to the reel must be static such that the repeated movement at the outfeed end does not disconnect the electronic device from the power supply. Therefore, there is a need in the art for a device to automatically retract wire from an electronic device, such as signage, as well as maintain the electrical connections.

In light of the devices disclosed in the known art, it is submitted that the present invention substantially diverges in design elements and methods from the known art and consequently it is clear that there is a need in the art for an improvement for self-retracting reel that accumulates excess wire to prevent the pulling of the wire from an exterior source such as a wall outlet. In this regard the instant invention substantially fulfills these needs.

### SUMMARY OF THE INVENTION

In view of the foregoing disadvantages inherent in the known types of retractable wire reels now present in the known art, the present invention provides a new retractable wire that comprises a self-retracting reel with a housing and rotatable drum, offering automatic wire retraction for efficient wire management including the ability to repeatably reposition or relocate the connected electronic device without needing to disconnect the wire.

It is an objective of the present invention to provide a self-retracting reel designed to protect wires from heat damage for stores that utilize grills or stoves, offering efficient wire management near heat sources.

It is another objective of the present invention to provide a self-retracting reel that accumulates the wire in an inner spool section to minimize tension on both the infeed wire section and the electrical wall outlet. This configuration ensures a secure and stable connection, reducing the risk of wire damage or disconnection.

It is another objective of the present invention to provide a self-retracting reel that manages wire tension by feeding wire from the inner spool to the outer spool during the transition from a retracted configuration to an extended configuration thereby keeping tension in the outfeed wire section and minimizing tension on the infeed wire section.

It is an objective of the present invention to incorporate a spring mechanism that biases the reel in a first direction, thereby maintaining tension on the outfeed wire section. This design ensures consistent and controlled wire retraction, minimizing slack and improving overall wire management and reliability.

It is an objective of the present invention to provide a self-retracting reel with an exterior housing that allows for the inclusion of a logo or branding, offering customizable options for personalization and brand recognition.

It is another objective of the present invention to provide a self-retracting reel that is utilized with a roller grill and rail system, wherein the electronic devices are mounted to the same rail, wherein a first sign unit extends from a front side thereof and a second sign unit extends from a rear side thereof, such that the signs are offset from one another. In this configuration, a pair of self-retracting reels are positioned on the grill and provide a wire that is connected to each sign.

It is therefore an object of the present invention to provide a new and improved self-retracting reel that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the self-retractable reel mounted to a roller grill.

FIG. 2 shows a side view of an embodiment of the self-retractable reel without a wire wound therearound.

FIG. 3 shows a front exploded view of an embodiment of the self-retractable reel.

FIG. 4 shows a rear exploded view of an embodiment of the self-retractable reel.

FIG. 5 shows a perspective view of an embodiment of the food self-retractable reel with the first bracket removed and drum being positioned over the spring and second bracket.

FIG. 6 shows a perspective view of an embodiment of the self-retractable reel used with a roller grill.

### DETAILED DESCRIPTION OF THE INVENTION

Reference is made herein to the attached drawings. Like reference numerals are used throughout the drawings to depict like or similar elements of the self-retractable reel. For the purpose of presenting a brief and clear description of the present invention, the embodiment discussed will be as used for electronically powering a movable sign. The figures are intended for representative purposes only and should not be considered to be limiting in any respect.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

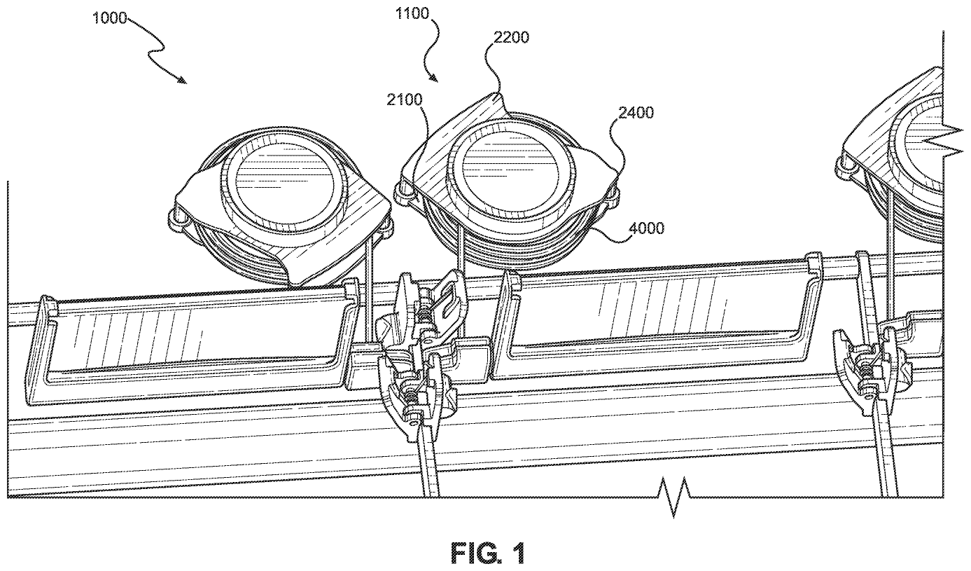

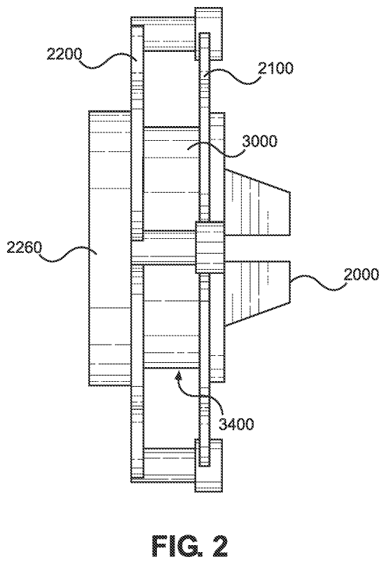

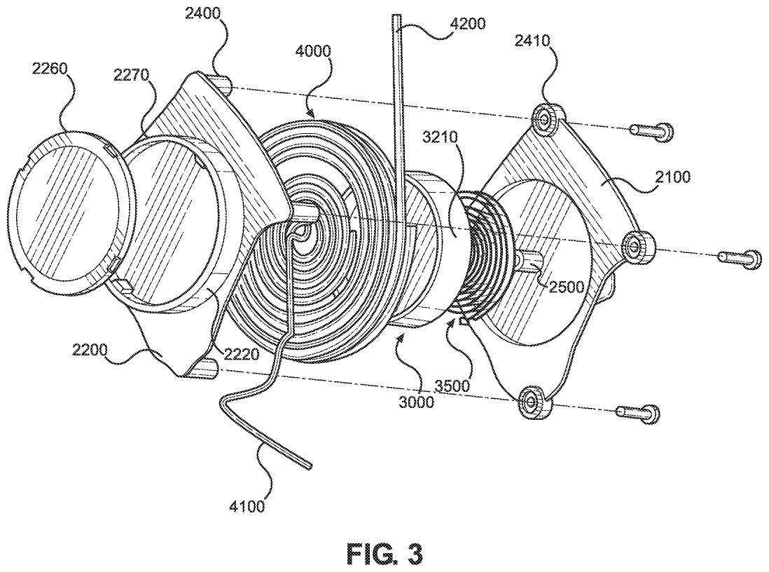

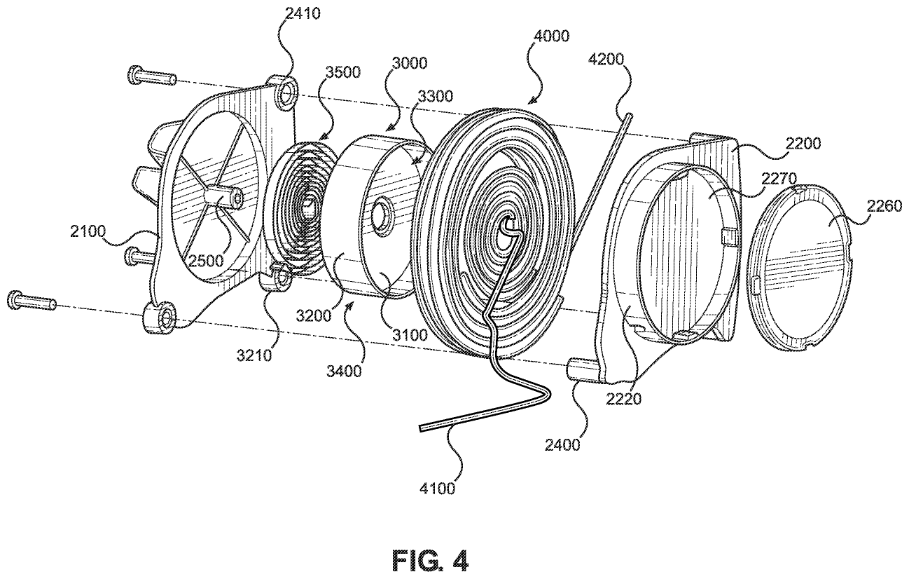

Referring now to FIGS. 1 and 2, there is shown a perspective view of an embodiment of the self-retractable reel mounted to a roller grill and a side view of an embodiment of the self-retractable reel without a wire wound therearound, respectively. The self-retractable reel 1000 allows a user to connect an electronic device to an external power source, such as a wall outlet, and keep the wire taut regardless of the position of the electronic device. The self-retractable reel 1000 comprises a housing 1100 having a first bracket 2100 removably joined with a second bracket 2200 spaced at an interval forming an interior volume therebetween. In the shown embodiment, the brackets 2100, 2200 are plate members that sandwich a drum 3000 having a removable wire 4000 wound therearound. The wire 4000 is entirely removable from the drum 3000 such that it may be replaced with different or the same gauge and/or length. The brackets 2100, 2200 are joined via one or more fasteners 2300 (as shown in FIGS. 3 and 4) that extend therebetween. The fasteners 2300 are adapted to extend through aligned tabs 2400 (as shown in FIGS. 3 and 4) disposed towards a perimeter of the brackets 2100, 2200. The tabs 2400 function as spacers that define the distance between the brackets 2100, 2200. The space between the tabs 2400 are open to allow for the wire to pass therethrough. In the shown embodiment, the tabs 2400 are dimensionally similar to each other such that the brackets 2100, 2200 lay entirely on parallel horizontal planes. In alternative embodiments, the brackets 2100, 2200 may be angled towards each other forming a taper.

In the shown embodiment, the drum 3000 is positioned between the first and second brackets 2100, 2200 and concentrically aligned with the center of the first and second brackets 2100, 2200. As seen in FIG. 2, the wire 4000 has been removed. The drum 3000 includes an outer spool area 3400 adapted to have the wire 4000 wound therearound. In the shown embodiment, the housing 1100 also includes a stand 2000 on the first bracket 2100 for mounting the housing 1100 to another object and a removable logo member 2260 disposed on the second bracket 2200. In the illustrated embodiment, the stand 2000 comprises a pair of feet members having a space therebetween. The space is configured to mount to a rail or other protrusion. In alternate embodiments, the stand 2000 comprises any suitable shape adapted to allow the reel to remain in an upright and stable position.

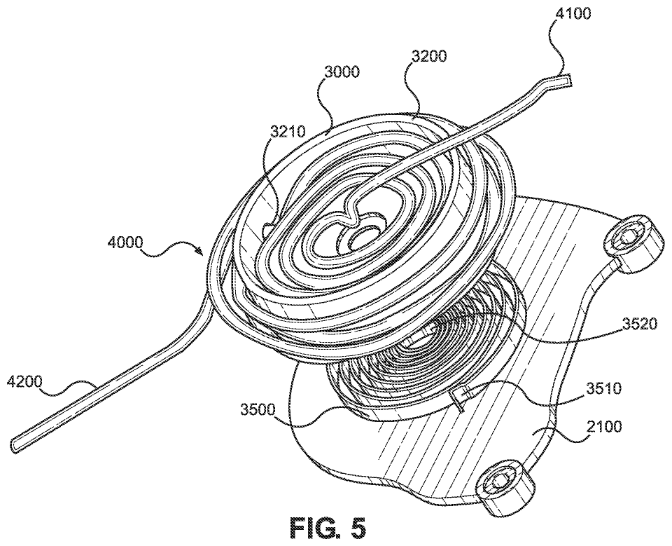

Referring now to FIGS. 3-5, there is shown a front exploded view and a rear exploded view of an embodiment of the self-retractable reel, and a perspective view of an embodiment of the food self-retractable reel with the first bracket removed and drum being positioned over the spring and second bracket, respectively. In the shown embodiment, the first bracket 2100 includes a central stem 2500 and the second bracket 2200 comprises one or more tabs 2400. The one or more tabs 2400 are adapted to be seated within corresponding connectors 2410 in the first bracket 2100, so as to align the first and second brackets 2100, 2200. Between the brackets 2100, 2200, a spring 3500, the drum 3000, and wire 4000 are arranged. The drum 3000 includes a base 3100 having a sidewall 3200 that extends around a perimeter thereof, wherein the sidewall 3200 forms an inner spool area 3300 adapted to receive a wire 4000. The inner spool area 3300 is configured to accumulate or otherwise store some length of wire 4000 therein. In one embodiment, a stem 2500 acts as a central hub from which the wire in the inner spool area 3300 is wound therearound. As the outfeed wire is pulled away causing the drum to rotate, the infeed wire is wound about the stem 2500. The drum 3000 is adapted to rotate independently from the first and second brackets 2100, 2200, wherein the drum 3000 comprises an outer spool area 3400 formed by an exterior side of the sidewall 3200. The outer spool area 3400 is adapted to receive a length of the wire 4000 therearound.

In the shown embodiment, the wire 4000 passes through a drum aperture 3210 disposed on the sidewall 3200 from the inner spool area. In this way, the wire 4000 is adapted to be positioned about the outer spool area 3400 and the inner spool area 3300. An infeed portion of the wire 4100 is fed through an infeed slot 2220 in the one of the brackets 2100, 2200 to the inner spool area 3300. In the shown embodiment, the infeed slot 2220 is disposed in the second bracket 2200.

In the shown embodiment, a spring 3500 is engaged with the drum 3000 such that the drum 3000 is biased in a first direction such that the drum is in a retracted configuration. In one embodiment, the first direction is clockwise when the first bracket 3100 is resting directly on a tabletop surface. In other embodiments, the first direction is counterclockwise. In the retracted configuration, an outfeed section 4200 of the wire 4000 extends from the drum 3000 and is positioned towards the housing 1100. In the extended configuration, the drum 3000 is rotated in a second direction such that the outfeed section 4200 of the wire 4000 is moved away from the housing 1100. In the extended configuration, the end of the wire 4000 is at a further distance from the housing when fully extended. As the end of the wire 4000 is pulled, the wire 4000 positioned in the outer spool area 3400 is unwound from the drum 3000 as the drum 3000 rotates. Since the infeed wire 4100 is fed through an opening in the one of the brackets 2100, 2200, as the drum 3000 rotates there is no tension placed on the infeed portion of the wire.

In the shown embodiment, the spring 3500 is a torsion spring having an aperture that aligns with the drum aperture 3210. The torsion spring 3500 includes a first catch 3510 that is removably connected with either the first or second bracket 2100, 2200 and a second catch 3520 on an opposing end of the spring 3500 that is removably connected to the drum 3200 such that as the drum 3200 rotates the torsion spring 3500 applies a biasing force in the first direction. In one embodiment, the bracket 2100, 2200 comprises an interior side having a recessed area 2150 sized to partially receive the spring 3500. In the shown embodiment, the first bracket includes the stem 2500. The stem 2500 is connected to one end of the spring 3500 while the other end of the spring is connected to the drum 3200, thereby promoting independent rotation of the drum 3200 relative to the brackets 2100, 2200. In other embodiments, the stem 2500 extends from either bracket or both brackets.

In the shown embodiment, the second bracket 2200, comprises a removable logo member 2260 that is removably seated in a logo receiver 2270. The logo member 2260 may have any shape, including a disk, trapezoidal, triangular, and the like. In other embodiments, the logo is embedded directly onto either bracket 2100, 2200. In the shown embodiment, the logo member 2260 is adapted to engage the receiver 2270 via corresponding tabs that when rotated lock into position with corresponding latches.

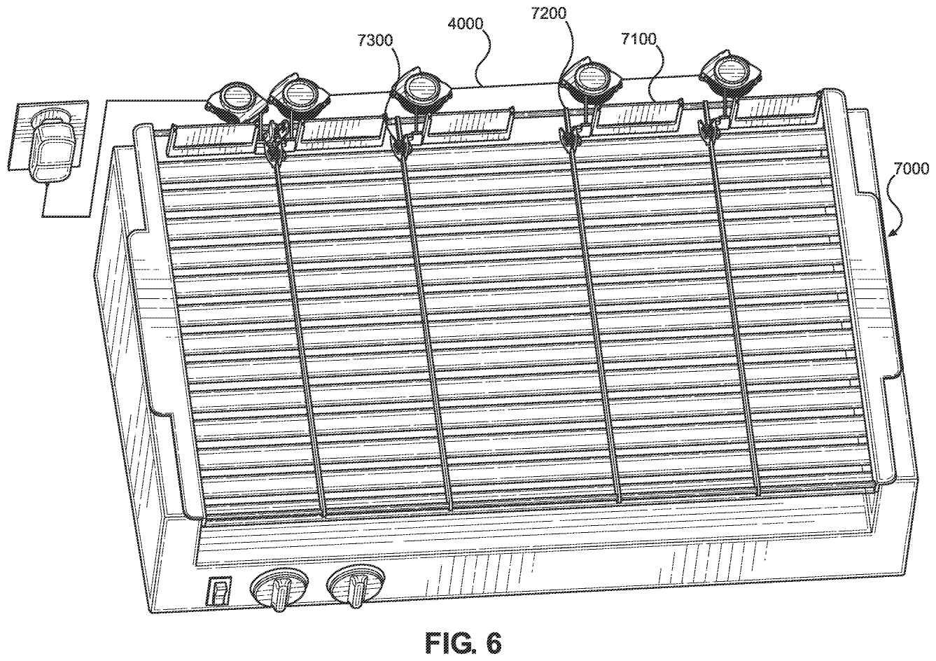

Referring now to FIG. 6, there is shown a perspective view of an embodiment of the self-retractable reel used with a roller grill. In the shown embodiment, a cooking apparatus, such as a roller grill 7000, comprises a plurality of signs 7100 that are positioned thereon. The signs include lights and an electrical connector that is removably connected to corresponding electrical connector disposed on the distal end of the wire of the self-retractable reel 1000. A foot member 7300 extends from the sign 7100 and is configured to engage with a rail 7200 that separates one cooking column from an adjacent cooking column of the cooking apparatus 7000. In the illustrated embodiment, the rail 7200 extends from a lower side to an upper side of the cooking apparatus 7000, allowing the sign unit to move between the lower side and the upper side of the cooking apparatus. The rail sits above the heating elements and allows the foot member to slide therealong. As the sign moves along the rail 7200, the wire 4000 extends and retracts as needed. The spring keeps tension on the outfeed portion of the wire 4000 to allow the wire to avoid the heated surface of the cooking apparatus. Additionally, the self-retractable reel 1000 does not alter the length of wire 4000 extended from the infeed portion, thereby ensuring consistent electronic connection. In one embodiment, the infeed portion of the wire wraps around the stem when the outfeed wire is extended.

In one embodiment, the wire 4000 is waterproof for convenient cleaning, making it suitable for use in environments where exposure to water or liquids may occur. The design ensures that the wire 4000 remains unaffected by moisture, preventing potential damage and maintaining optimal performance. Additionally, the wire 4000 is intentionally exposed on the outer reel for cleaning purposes, allowing for easy access and thorough cleaning when needed. This feature ensures that any dust, debris, or contaminants accumulated on the wire's surface can be promptly removed, further enhancing the reel's overall efficiency and longevity.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A self-retractable wire reel, comprising:
a housing having a first bracket removably joined with a second bracket spaced at an interval;
wherein a drum is positioned between the first and second brackets;
a drum including a base having a sidewall extend around a perimeter thereof, wherein the sidewall forms an inner spool area adapted to receive a wire;
wherein the drum is adapted to rotate independently from the first and second brackets;
wherein the drum comprises an outer spool area formed by an exterior side of the sidewall, wherein the outer spool area is adapted to receive the wire therearound, wherein the wire passes through a drum aperture from the inner spool area;
a spring engaged with the drum such that the drum is biased in a first direction.

2. The self-retractable wire reel of claim 1, wherein the drum is adapted to transition from a retracted configuration to an extended configuration, wherein the retraction configuration the drum is rotated in the first direction and an outfeed section of the wire extending from the drum is positioned towards the housing.

3. The self-retractable wire reel of claim 2, wherein the extended configuration the drum is rotated in a second direction such that the outfeed section of the wire is moved away from the housing.

4. The self-retractable wire reel of claim 3, further comprising a wire coiled about the sidewall.

5. The self-retractable wire reel of claim 4, wherein the inner spool area is configured to accumulate a length of the wire, such that as the drum transitions to the extended configuration, the wire from the inner spool area is pulled through the drum aperture without applying a tensioning force on the wire leading to the external power source.

6. The self-retractable wire reel of claim 5, wherein either the first or second bracket comprises a slot sized to receive the wire.

7. The self-retractable wire reel of claim 5, wherein either the first or second bracket comprises a raised lip that encloses the slot having an aperture, such that the wire protrudes through the aperture and through the slot from an exterior source, such that the wire is coiled about the drum.

8. The self-retractable wire reel of claim 7, wherein at least one bracket comprises a spacer that defines the interval between the first and second brackets.

9. The self-retractable wire reel of claim 8, wherein the spacer is centrally located and comprises a plurality of tabs disposed on an outer perimeter, wherein the spacer comprises an aperture adapted to receive a fastener to secure the first bracket with the second bracket.

10. The self-retractable wire reel of claim 9, wherein the spring is a torsion spring.

11. The self-retractable wire reel of claim 10, wherein the torsion spring includes a first catch that is connected with either the first or second bracket and a second catch on an opposing end of the spring that is connected to the drum, such that as the drum rotates, the torsion spring applies a biasing force in the first direction.

12. The self-retractable wire reel of claim 11, wherein either the first or second bracket include a stem that extends from the bracket and connects to one end of the spring.

13. The self-retractable wire reel of claim 12, wherein the spring comprises an aperture that aligns with the stem.

14. The self-retractable wire reel of claim 13, wherein each the first and second bracket each comprise an interior side having a recessed area sized to partially receive the spring.

15. The self-retractable wire reel of claim 1, wherein an exterior side of the housing comprises a logo receiving area adapted to receive an advertisement member thereon.

16. The self-retractable wire reel of claim 1, wherein the wire comprises an electrical contact at a distal end thereof.

17. The self-retractable wire reel of claim 16, further comprising a sign unit with a light source, wherein the sign unit is adapted to secure to and slide along a rail.

18. The self-retractable wire reel of claim 17, wherein the sign unit and rail are positioned atop a cooking apparatus.
